(19) United States
(12) Patent Application Publication
(10) Pub. No.: US 2025/0293371 A1
(43) Pub. Date: Sep. 18, 2025

(54) ELECTRIC STORAGE APPARATUS AND VEHICLE MOUNTING STRUCTURE OF ELECTRIC STORAGE APPARATUS

(71) Applicant: TOYOTA JIDOSHA KABUSHIKI KAISHA, Toyota-shi (JP)

(72) Inventors: Naoya KAWAMOTO, Nisshin-shi (JP); Shigeyuki INOUE, Toyota-shi (JP); Nobuyoshi FUJIWARA, Nagoya-shi (JP); Kenta KIMURA, Toyota-shi (JP)

(73) Assignee: TOYOTA JIDOSHA KABUSHIKI KAISHA, Toyota-shi (JP)

(21) Appl. No.: 19/045,713

(22) Filed: Feb. 5, 2025

(30) Foreign Application Priority Data
Mar. 18, 2024 (JP) 2024-042418

(51) Int. Cl. H01M 50/256; B60K 1/04; H01M 50/242; H01M 50/249; H01M 50/262; H01M 50/293; H01M 50/548

(52) U.S. Cl. CPC H01M 50/256; B60K 1/04; H01M 50/242; H01M 50/249; H01M 50/262; H01M 50/293; H01M 50/548; B60K 2001/0438

(57) ABSTRACT

An electric storage apparatus which contributes to the improvement of maintainability of the inside of the electric storage apparatus is provided. An electric storage apparatus according to the present disclosure includes: a battery module including a plurality of battery cells; a case configured to house at least a part of the battery module; an apparatus component positioned between the battery module and the case; and an adhesive member configured to bond the apparatus component to the battery module, in which the electric storage apparatus includes a wire rod including a first part disposed inside the electric storage apparatus and a second part disposed outside the electric storage apparatus.

### CROSS REFERENCE TO RELATED APPLICATIONS

This application is based upon and claims the benefit of priority from Japanese patent application No. 2024-42418, filed on Mar. 18, 2024, the disclosure of which is incorporated herein in its entirety by reference.

### BACKGROUND

The present disclosure relates to an electric storage apparatus and a vehicle mounting structure of the electric storage apparatus.

For example, in the electric storage apparatus disclosed in Patent Literature 1, a case is formed by right and left rockers, a front cross member, a rear cross member, a floor pan, and a bottom part, and battery modules are housed in small spaces partitioned inside the case by a center tunnel and an intermediate cross member. Note that, in the electric storage apparatus disclosed in Patent Literature 1, the floor pan also serves as a floor panel of a vehicle.
Patent Literature 1: Japanese Unexamined Patent Application Publication No. 2018-202946

### SUMMARY

For example, in the electric storage apparatus disclosed in Patent Literature 1, when a surface pressure dispersion member is disposed between a battery cell and an upper case and then fixed by an adhesive member in order to distribute inputs to the battery cell from above, the maintainability of the inside of the electric storage apparatus deteriorates.

The present disclosure has been made in view of the above-described problem and provides an electric storage apparatus and a vehicle mounting structure of the electric storage apparatus which contribute to the improvement of maintainability of the inside of the electric storage apparatus.

An electric storage apparatus according to an aspect of the present disclosure includes:
a battery module including a plurality of battery cells;
a case configured to house at least a part of the battery module;
an apparatus component positioned between the battery module and the case; and
an adhesive member configured to bond the apparatus component to the battery module,
in which the electric storage apparatus includes a wire rod including a first part disposed inside the electric storage apparatus and a second part disposed outside the electric storage apparatus.

In the above-described electric storage apparatus, the wire rod preferably has an insulation property.

In the above-described electric storage apparatus, the first part of the wire rod preferably includes a part disposed at a position where the part overlaps the battery module as viewed from a direction in which the battery module and the apparatus component face each other.

In the above-described electric storage apparatus, the first part of the wire rod preferably includes a part fixed at a position where the part overlaps the battery module as viewed from a direction in which the battery module and the apparatus component face each other.

In the above-described electric storage apparatus, the first part of the wire rod preferably includes a part that is in contact with the adhesive member.

In the above-described electric storage apparatus, the first part of the wire rod preferably is curved as viewed from a direction in which the battery module and the apparatus component face each other.

In the above-described electric storage apparatus, the wire rod is preferably disposed inside the adhesive member.

In the above-described electric storage apparatus,
the apparatus component is preferably a surface pressure dispersion member,
the adhesive member preferably includes a first adhesive member configured to join the surface pressure dispersion member to the case, and a second adhesive member configured to join the surface pressure dispersion member to the battery module, and
the wire rod is preferably disposed inside the first adhesive member.

The above-described electric storage apparatus preferably includes a load receiving member disposed between each adjacent pair of the battery cells, a load being transmitted from the surface pressure dispersing member to each of the load receiving members.

In the above-described electric storage apparatus, the surface pressure dispersion member preferably includes ribs protruding so that each one of them is disposed between each adjacent pair of the battery cells, the ribs being configured to press the load receiving members.

In the above-described electric storage apparatus, the load receiving member preferably has an insulation property.

In the above-described electric storage apparatus, the battery cell preferably includes an electrode terminal on at least one of a pair of surfaces thereof that face each other in a direction perpendicular to a direction in which the battery module and the apparatus component face each other.

In the above-described electric storage apparatus, the apparatus component preferably forms at least a part of the case.

A vehicle mounting structure of the above-described electric storage apparatus includes:
a first vehicle frame member disposed above the battery module and extending in a width direction of a vehicle; and
a second vehicle frame member disposed above the battery module so as to be spaced apart from the first vehicle frame member in a front-rear direction of the vehicle and extending in the width direction of the vehicle, in which
the apparatus component is a surface pressure dispersion member, and
the surface pressure dispersion member is disposed between the first vehicle frame member and the second vehicle frame member.

In the above-described vehicle mounting structure of the electric storage apparatus, each of the first vehicle frame member and the second vehicle frame member is preferably a seat cross.

An electric storage apparatus according to an aspect of the present disclosure includes:
a battery module including a plurality of battery cells;
a case configured to house at least a part of the battery module; and
an adhesive member configured to bond the case to the battery module,
in which the electric storage apparatus includes a wire rod including a first part disposed at a position where the first part overlaps the battery module as viewed from a direction in which the battery module and the case face each other, and a second part disposed at a position where the second part does not overlap the battery module as viewed from a direction in which the battery module and the case face each other.

In the above-described electric storage apparatus, the battery cell preferably includes an electrode terminal on at least one of a pair of surfaces thereof that face each other in a direction perpendicular to a direction in which the battery module and the case face each other.

According to the present disclosure, it is possible to provide an electric storage apparatus and a vehicle mounting structure of the electric storage apparatus which contribute to the improvement of maintainability of the inside of the electric storage apparatus.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a state in which an electric storage apparatus according to a first embodiment is mounted on a vehicle;

FIG. 2 is an exploded view showing the electric storage apparatus according to the first embodiment in a simplified manner;

FIG. 3 is a diagram for explaining an arrangement of a surface pressure dispersion member, an adhesive member, a wire rod, and the like in the electric storage apparatus according to the first embodiment;

FIG. 4 is a partial Y-Z cross-sectional view of the electric storage apparatus according to the first embodiment;

FIG. 5 is a Y-Z cross-sectional view for explaining an arrangement and the like of the adhesive member, the surface pressure dispersion member, and a battery module in the electric storage apparatus according to the first embodiment;

FIG. 6 is an X-Z cross-sectional view of the electric storage apparatus according to the first embodiment;

FIG. 7 is an X-Z cross-sectional view for explaining an arrangement and the like of the surface pressure dispersion member, the adhesive member, and the battery cell in the electric storage apparatus according to the first embodiment;

FIG. 8 is an X-Z cross-sectional view showing an example of the surface pressure dispersion member in the electric storage apparatus according to the first embodiment;

FIG. 9 is an X-Z cross-sectional view showing an example of the surface pressure dispersion member in the electric storage apparatus according to the first embodiment;

FIG. 10 is an X-Z cross-sectional view for explaining a vehicle mounting structure of an electric storage apparatus according to a second embodiment;

FIG. 11 is a perspective view for explaining an arrangement of a surface pressure dispersion member in the electric storage apparatus according to the second embodiment;

FIG. 12 is a Y-Z cross-sectional view of the vehicle mounting structure of the electric storage apparatus taken along a line XII-XII shown in FIG. 10;

FIG. 13 is a Y-Z cross-sectional view of the vehicle mounting structure of the electric storage apparatus taken along a line XIII-XIII shown in FIG. 10;

FIG. 14 is a diagram for explaining a configuration of an electric storage apparatus according to a third embodiment between battery cells adjacent to each other in the X-axis direction;

FIG. 15 is a Y-Z cross-sectional view for explaining an arrangement of an adhesive member, a cooling apparatus, a battery module, and the like in an electric storage apparatus according to a fourth embodiment;

FIG. 16 is a Y-Z cross-sectional view for explaining an arrangement of an adhesive member, an apparatus component, a battery module, and the like in an electric storage apparatus according to a fifth embodiment; and

FIG. 17 is an X-Z cross-sectional view showing an example of a surface pressure dispersion member in an electric storage apparatus according to another embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate. Note that the following description will be given using a three-dimensional (XYZ) coordinate system in order to clarify the description.

### First Embodiment

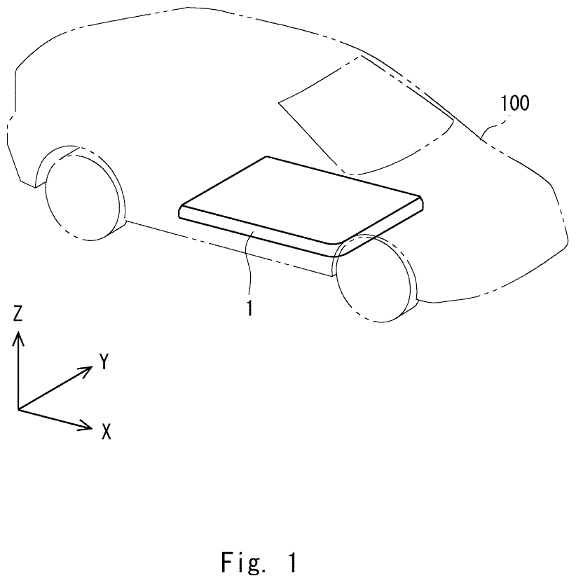

First, a configuration of an electric storage apparatus according to this embodiment will be described. FIG. 1 is a diagram showing a state in which the electric storage apparatus according to this embodiment is mounted on a vehicle. For example, as shown in FIG. 1, an electric storage apparatus 1 is suitably used as an electric storage apparatus mounted on a vehicle 100.

In FIG. 1, the X-axis positive side is a front side of the vehicle 100, and the X-axis negative side is a rear side of the vehicle 100. The Y-axis positive side is a left side of the vehicle 100, and the Y-axis negative side is a right side of the vehicle 100. The Z-axis positive side is an upper side of the vehicle 100, and the Z-axis negative side is a lower side of the vehicle 100.

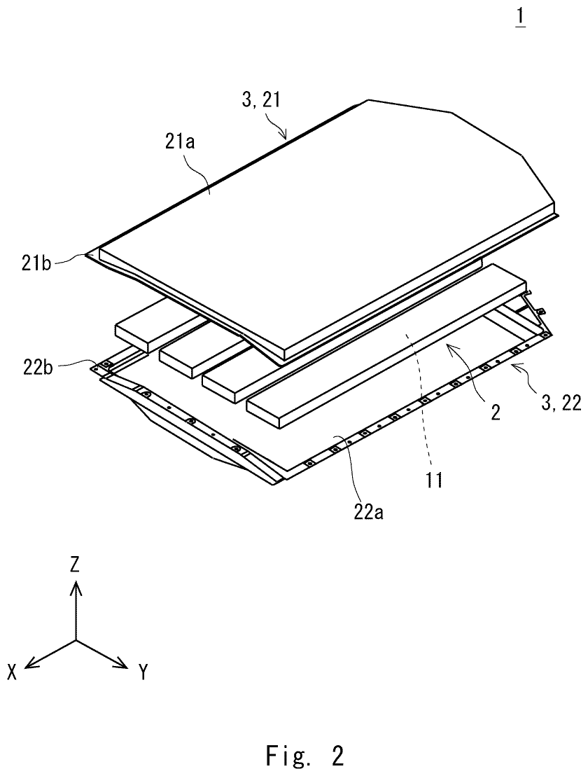

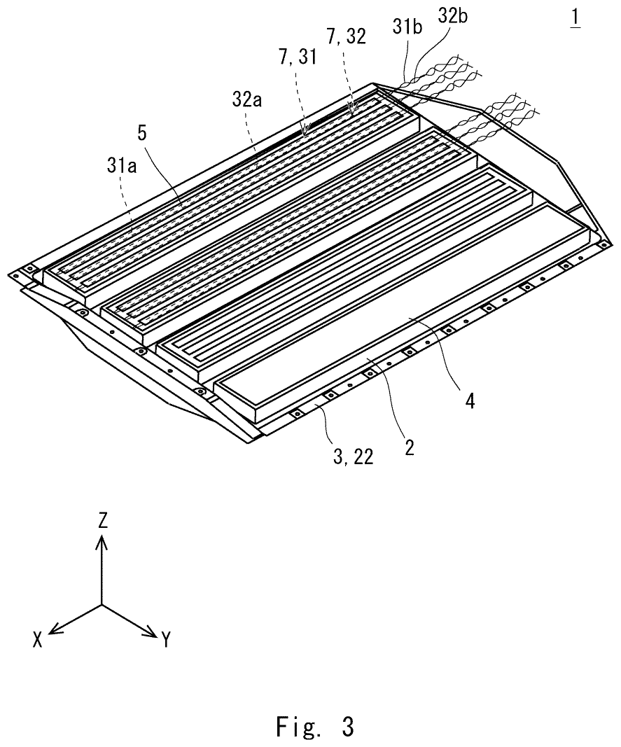

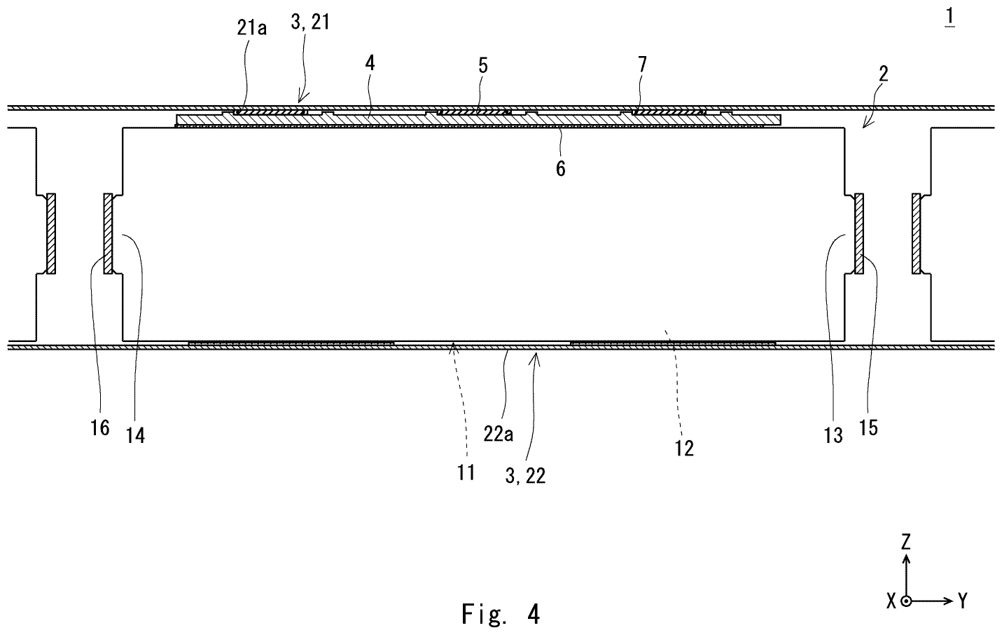

FIG. 2 is an exploded view showing the electric storage apparatus according to this embodiment in a simplified manner. FIG. 3 is a diagram for explaining an arrangement of a surface pressure dispersion member, an adhesive member, a wire rod, and the like in the electric storage apparatus according to this embodiment. FIG. 4 is a partial Y-Z cross-sectional view of the electric storage apparatus according to this embodiment.

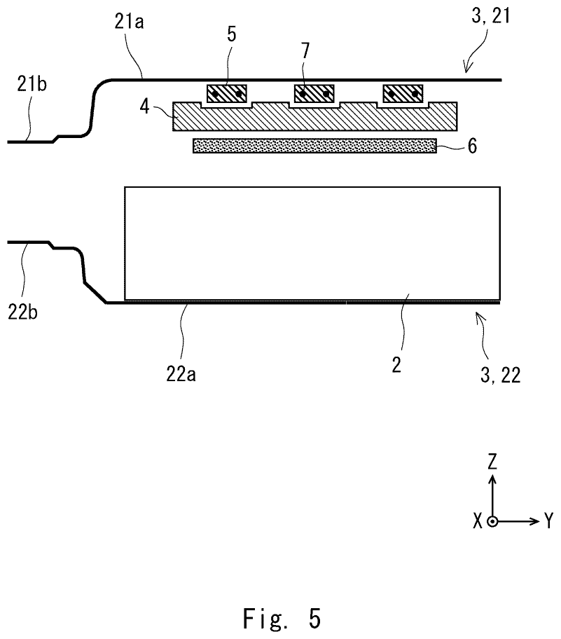

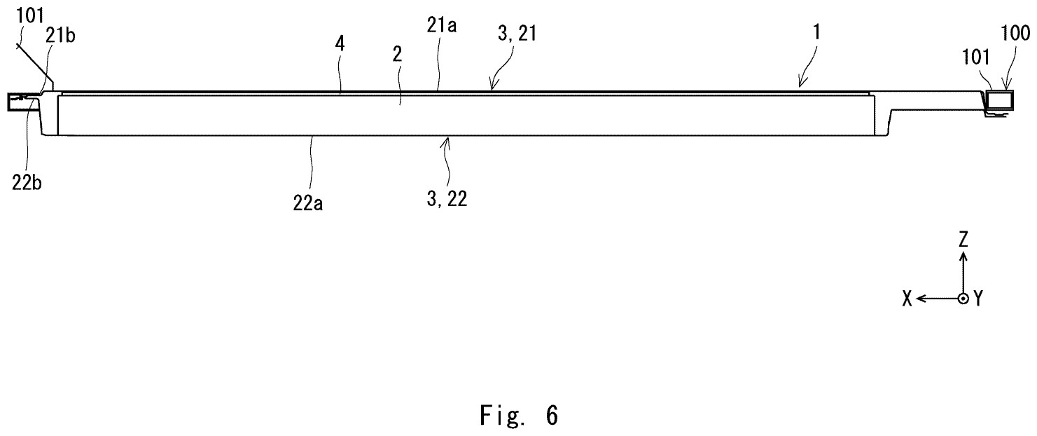

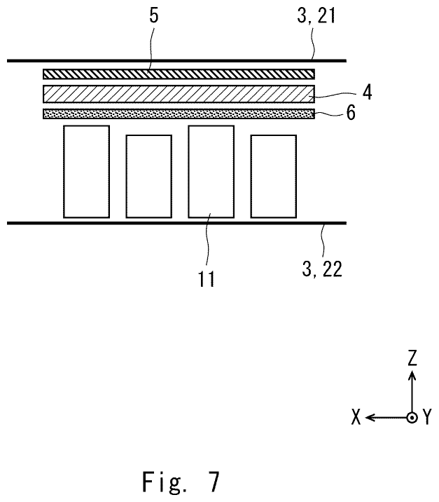

FIG. 5 is a Y-Z cross-sectional view for explaining an arrangement and the like of the adhesive member, the surface pressure dispersion member, and a battery module in the electric storage apparatus according to this embodiment. FIG. 6 is an X-Z cross-sectional view of the electric storage apparatus according to this embodiment. FIG. 7 is an X-Z cross-sectional view for explaining an arrangement and the like of the surface pressure dispersion member, the adhesive member, and a battery cell in the electric storage apparatus according to this embodiment.

As shown in FIGS. 2 to 7, the electric storage apparatus 1 includes a battery module 2, a pack case 3, a surface pressure dispersion member 4, first adhesive members 5, a second adhesive member 6, and wire rods 7. The battery module 2 includes a plurality of battery cells 11.

As shown in FIG. 4, the battery cell 11 comprises, for example, an electrode body housed inside a battery case 12. A first electrode terminal 13, which is one of a positive electrode terminal and a negative electrode terminal, is provided in an end part of the battery case 12 on the Y-axis positive side thereof, and a second electrode terminal 14, which is the other of the positive electrode terminal and the negative electrode terminal, is provided in an end part of the battery case 12 on the Y-axis negative side thereof.

In a case in which, for example, the first electrode terminal 13 and the second electrode terminal 14 are provided in the end part of the battery case 12 on the Z-axis positive side thereof, the first electrode terminal 13 and the second electrode terminal 14 may be short-circuited when a load is input to the electric storage apparatus 1 from the Z-axis positive side thereof.

In a case in which the first electrode terminal 13 and the second electrode terminal 14 are provided on the side surface of the battery case 12 like in the case of this embodiment, it is possible to reduce the number of occurrences of a short circuit between the first electrode terminal 13 and the second electrode terminal 14 when a load is input to the electric storage apparatus 1 from the Z-axis positive side thereof.

The battery cells 11 described above are stacked in the X-axis direction so that the positive electrode terminal and the negative electrode terminal are disposed alternately in the X-axis direction on each of the Y-axis positive side and the Y-axis negative side of the battery module 2.

Further, as shown in FIG. 4, the first electrode terminals 13 adjacent to each other in the X-axis direction are electrically connected through a first bus bar 15 on the Y-axis positive side of the battery module 2, and the second electrode terminals 14 adjacent to each other in the X-axis direction are electrically connected through a second bus bar 16 on the Y-axis negative side of the battery module 2. Thus, the battery cells 11 constituting the battery module 2 are electrically connected to each other in series.

As shown in FIGS. 2 to 7, the pack case 3 houses the battery module 2. The pack case 3 includes an upper case 21 and a lower case 22. The upper case 21 includes, for example, a housing part 21a which is configured so as to rise up toward the Z-axis positive side and includes an internal space in which the battery module 2 can be housed, and a flange part 21b which protrudes outward from the periphery of the housing part 21a.

As shown in FIGS. 2 to 7, the lower case 22 includes, for example, a housing part 22a which is recessed toward the Z-axis negative side and includes an internal space in which the battery module 2 can be housed, and a flange part 22b which protrudes outward from the periphery of the housing part 22a.

The flange part 21b of the upper case 21 and the flange part 22b of the lower case 22 are joined to each other by an adhesive member while the battery modules 2 disposed at predetermined intervals in the Y-axis direction are housed inside the housing part 21a of the upper case 21 and the housing part 22a of the lower case 22.

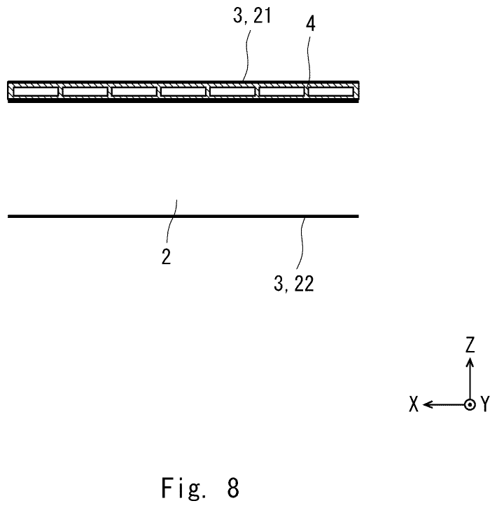

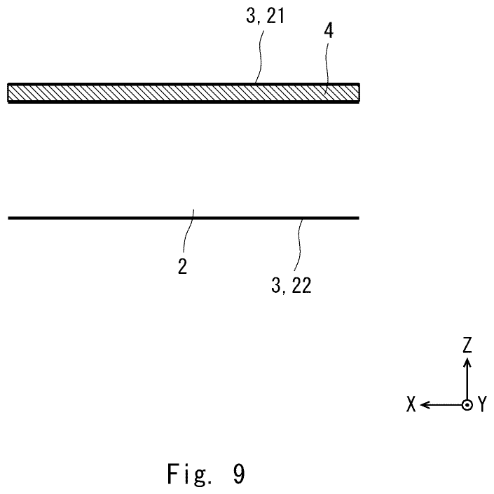

The surface pressure dispersion member 4 is a typical example of an apparatus component of the electric storage apparatus 1. The surface pressure dispersion member 4 distributes a load input to the electric storage apparatus 1 from the Z-axis positive side thereof to the surrounding battery cells 11 so that the load is not concentrated on one of the battery cells 11. As shown in FIGS. 3 to 7, the surface pressure dispersion member 4 is disposed between the battery module 2 and the housing part 21a of the upper case 21. Note that each of FIGS. 8 and 9 is an X-Z cross-sectional view showing an example of the surface pressure dispersion member in the electric storage apparatus according to this embodiment.

The surface pressure dispersion member 4 has a substantially rectangular plate body that is long in the Y-axis direction, and may be, for example, a hollow extrusion member made of aluminum or the like as shown in FIG. 8 or a solid rigid member made of resin or the like as shown in FIG. 9. Note that the surface pressure dispersion member 4, for example, may cover substantially the entire area of the battery module 2 in the Y-axis direction as shown in FIG. 3.

As shown in FIGS. 3 to 7, the first adhesive member 5 joins the surface pressure dispersion member 4 to the upper case 21. The first adhesive member 5 is formed of, for example, an adhesive sheet in which the Z-axis positive side surface and the Z-axis negative side surface of the first adhesive member 5 are coated with adhesive. Note that, in FIG. 3, some of the first adhesive members 5 are omitted for the sake of simplicity.

As shown in FIG. 3, the first adhesive member 5, for example, extends in the X-axis direction on the Z-axis positive side surface of each of the surface pressure dispersion members 4. Further, the first adhesive members 5 are disposed at intervals in the Y-axis direction on the Z-axis positive side surface of each of the surface pressure dispersion members 4. Note that, as shown in FIG. 5 and the like, a recessed part for positioning the first adhesive member 5 may be formed on the Z-axis positive side surface of the surface pressure dispersion member 4 so that it extends in the X-axis direction.

As shown in FIGS. 4 and 5, the second adhesive member 6 joins the battery module 2 to the surface pressure dispersion member 4. The second adhesive member 6 may have adhesiveness and flexibility, and may be made of, for example, butyl.

By doing the above, even when a manufacturing error has occurred in the height of each of the battery cells 11 in the Z-axis direction (a second direction) as shown in FIG. 7, the manufacturing error is absorbed by the flexibility of the second adhesive member 6, and the surface pressure dispersion member 4 can be satisfactorily joined to each of the battery cells 11. Therefore, the load input to the surface pressure dispersion member 4 from the Z-axis positive side can be satisfactorily distributed to each of the battery cells 11 through the surface pressure dispersion member 4.

The wire rod 7 is used, for example, in order to cut the first adhesive member 5. The wire rod 7 may have, for example, a rigidity so that the first adhesive member 5 can be cut, and have an insulation property. The wire rod 7 can be formed of, for example, a piano wire coated with an insulating film.

In this embodiment, a first wire rod 31 and a second wire rod 32 are disposed as the wire rods 7 for each of first adhesive members 5. As shown in FIG. 3, the first wire rod 31 includes a first part 31a and a second part 31b. Note that, in FIG. 3, some of the wire rods 7 are omitted for the sake of simplicity.

The first part 31a is disposed inside the electric storage apparatus 1 as shown in FIG. 3. For example, the first part 31a is curved in a substantially trapezoidal shape as viewed from the Z-axis direction, and is disposed so as to surround a part of the first adhesive member 5 on the Y-axis negative side thereof.

Specifically, an end part of the first part 31a on the X-axis positive side thereof is fixed to an end part of the battery module 2 on the X-axis positive side thereof on an axis extending in the X-axis direction so as to pass substantially through the center of the first adhesive member 5 in the Y-axis direction.

Further, as shown in FIG. 3, the first part 31a is inclined toward the Y-axis negative side as it becomes closer to the X-axis negative side, and then extends toward the X-axis negative side in a state in which it is inserted into an end part of the first adhesive member 5 on the Y-axis negative side thereof. That is, at least a part of the first part 31a is fixed in a state in which it is disposed at a position where it overlaps the battery module 2 as viewed from the Z-axis direction.

Further, as shown in FIG. 3, the first part 31a protrudes from the first adhesive member 5 toward the X-axis negative side, and is then inclined toward the Y-axis positive side as it becomes closer to the X-axis negative side. Note that an end part of the first part 31a on the X-axis negative side thereof is disposed on an axis extending in the X-axis direction so as to pass substantially through the center of the first adhesive member 5 in the Y-axis direction.

The second part 31b is disposed outside the electric storage apparatus 1 as shown in FIG. 3. The second part 31b, for example, extends from the first part 31a toward the X-axis negative side. Note that an end part of the second part 31b on the X-axis negative side thereof may protrude toward the X-axis negative side from the pack case 3 through an adhesive member that joins the flange part 21b of the upper case 21 to the flange part 22b of the lower case 22.

As shown in FIG. 3, since the second wire rod 32 and the first wire rod 31 are, as viewed from the Z-axis direction, line-symmetrical with an axis extending in the X-axis direction so as to pass substantially through the center of the first adhesive member 5 in the Y-axis direction as an axis of symmetry, the second wire rod 32 includes the first part 32a and the second part 32b, although the detailed descriptions thereof will be omitted.

Note that, as shown in FIG. 3, the second part 31b of the first wire rod 31 and the second part 32b of the second wire rod 32 may be knitted so as to be easily grasped by a worker. As shown in FIG. 6, the electric storage apparatus 1 described above, for example, may be fixed to a frame-shaped frame 101 of the vehicle 100 from below.

Note that, for example, the upper case 21 of the electric storage apparatus 1 may form a floor surface (a floor panel) of a vehicle interior part of the vehicle 100. Further, when the upper case 21 of the electric storage apparatus 1 forms the floor surface of the vehicle interior part of the vehicle 100, a floor mat, a floor silencer, or the like may be disposed on the surface of the upper case 21 of the electric storage apparatus 1 on the Z-axis positive side thereof.

Next, a flow in which the electric storage apparatus 1 according to this embodiment is disassembled will be described. For example, in a state in which the electric storage apparatus 1 has been removed from the vehicle 100, a worker pulls the second part 31b of the first wire rod 31 and the second part 32b of the second wire rod 32 toward the X-axis negative side.

By doing so, since the first part 31a of the first wire rod 31 is disposed so as to surround a part of the first adhesive member 5 on the Y-axis negative side thereof as viewed from the Z-axis direction, it is deformed into a linear shape as the first wire rod 31 is pulled toward the X-axis negative side, to thereby cut the part of the first adhesive member 5 on the Y-axis negative side thereof.

Similarly, since the first part 32a of the second wire rod 32 is disposed so as to surround a part of the first adhesive member 5 on the Y-axis positive side thereof as viewed from the Z-axis direction, it is deformed into a linear shape as the second wire rod 32 is pulled toward the X-axis negative side, to thereby cut the part of the first adhesive member 5 on the Y-axis positive side thereof. As a result, the first adhesive member 5 can be cut.

When the first adhesive member 5 is cut by repeating the above-described steps, the surface pressure dispersion member 4 and the upper case 21 are disjoined from each other. Further, when a worker opens the upper case 21 with respect to the lower case 22, the electric storage apparatus 1 can be disassembled.

As described above, the electric storage apparatus 1 according to this embodiment can easily cut the first adhesive member 5 by pulling the first wire rod 31 and the second wire rod 32 toward the X-axis negative side. Therefore, the electric storage apparatus 1 according to this embodiment can be easily disassembled, for example, when the battery cell 11 inside the electric storage apparatus 1 is recycled or when devices such as a Satellite Battery Module (SBM) disposed inside the electric storage apparatus 1 are replaced, and hence the maintainability of the electric storage apparatus 1 can be improved.

Moreover, in the electric storage apparatus 1 according to this embodiment, since the first wire rod 31 and the second wire rod 32 have insulation properties, the number of occurrences of a short circuit between the battery cells 11 can be reduced. Further, since the first wire rod 31 and the second wire rod 32 are disposed inside the first adhesive member 5, the first wire rod 31 and the second wire rod 32 can be stabilized inside the electric storage apparatus 1 in a state in which they are supported by the first adhesive member 5.

### Second Embodiment

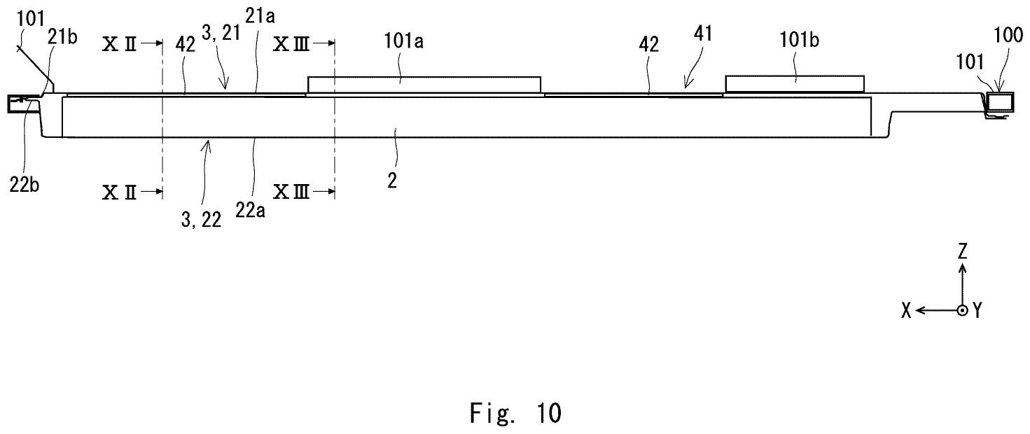

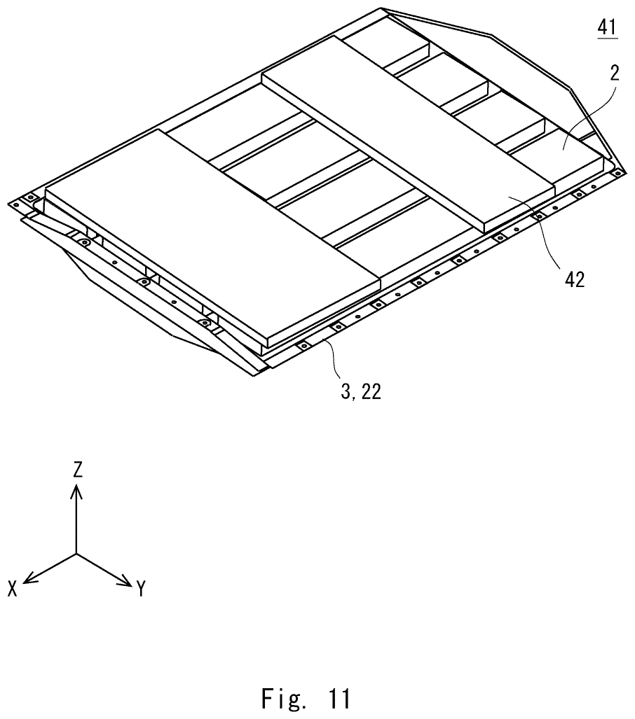

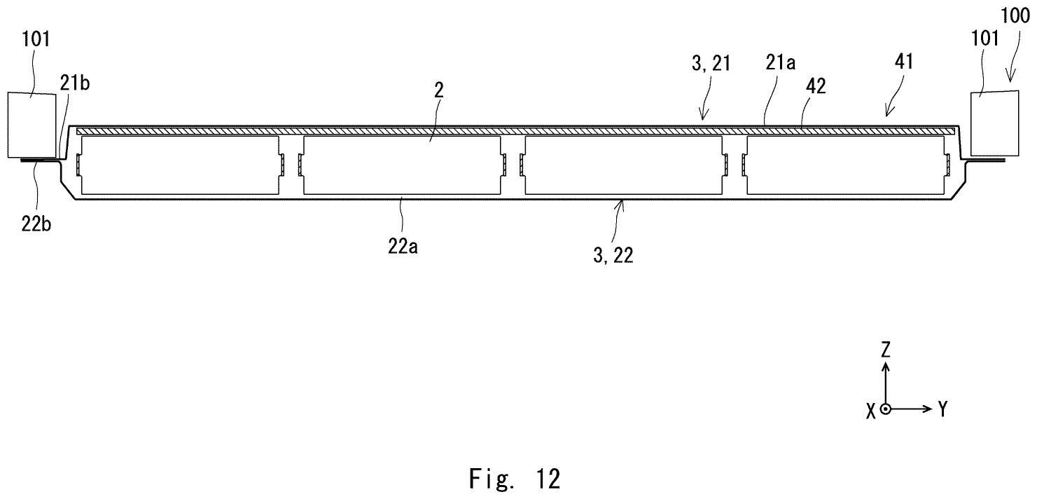

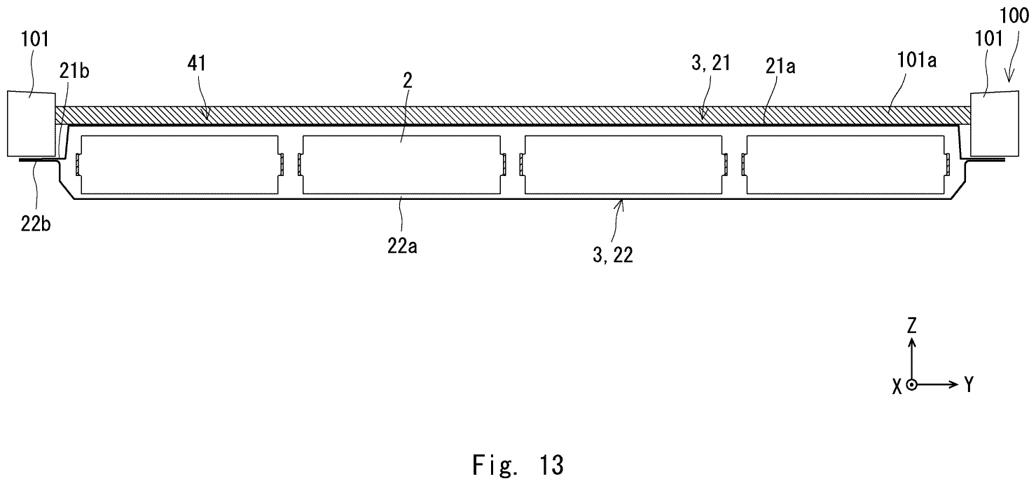

FIG. 10 is an X-Z cross-sectional view for explaining a vehicle mounting structure of an electric storage apparatus according to this embodiment. FIG. 11 is a perspective view for explaining an arrangement of a surface pressure dispersion member in the electric storage apparatus according to this embodiment. FIG. 12 is a Y-Z cross-sectional view of the vehicle mounting structure of the electric storage apparatus taken along a line XII-XII shown in FIG. 10. FIG. 13 is a Y-Z cross-sectional view of the vehicle mounting structure of the electric storage apparatus taken along a line XIII-XIII shown in FIG. 10.

Note that an electric storage apparatus 41 according to this embodiment has a configuration substantially the same as that of the electric storage apparatus 1 according to the first embodiment, and thus redundant descriptions thereof will be omitted and the same members will be described using the same reference symbols. Note that, in FIGS. 10 to 13, the wire rods 7 and the like are omitted.

As shown in FIGS. 10 to 13, regarding a structure in which the electric storage apparatus 41 according to this embodiment is mounted on the vehicle 100, as viewed from the Z-axis direction, the electric storage apparatus 41 is fixed to the frame 101 of the vehicle 100 so that surface pressure dispersion members 42 are disposed so as to avoid an area where a first vehicle frame member 101a and a second vehicle frame member 101b forming a part of the frame 101 of the vehicle 100 are disposed.

That is, as shown in FIG. 11, the electric storage apparatus 41 has a configuration in which, as viewed from the Z-axis direction, the surface pressure dispersion members 42 are disposed so as to avoid an area where the first vehicle frame member 101a and the second vehicle frame member 101b are disposed when the electric storage apparatus 41 is fixed to the frame 101 of the vehicle 100.

Each of the first vehicle frame member 101a and the second vehicle frame member 101b may be, for example, a seat cross used to fix the seat of the vehicle 100, and extends in the Y-axis direction as shown in FIGS. 10 and 13.

As shown in FIGS. 10 to 13, the surface pressure dispersion members 42 may be disposed so as to extend over the battery modules 2 adjacent to each other in the Y-axis direction. Further, for example, as shown in FIG. 10, the surface pressure dispersion member 42 may be disposed, as viewed from the Y-axis direction, in each of an area on the X-axis positive side with respect to the first vehicle frame member 101a and an area between the first vehicle frame member 101a and the second vehicle frame member 101b.

Note that the first adhesive members 5 may extend in the X-axis direction between each one of the surface pressure dispersion members 42 and the upper case 21, and may be disposed at intervals in the Y-axis direction in an area where they overlap the battery modules 2 as viewed from the Z-axis direction.

Further, the wire rods 7 may be disposed so as to extend over the first adhesive members 5 aligned in the X-axis direction. Further, the second adhesive member 6 may be disposed between each of the surface pressure dispersion members 42 and each of the battery modules 2.

That is, as compared with the electric storage apparatus 1 according to the first embodiment, the electric storage apparatus 41 according to this embodiment can have a configuration in which, for example, in an area where the surface pressure dispersion members 42 are not disposed, the first adhesive member 5 and the second adhesive member 6 are omitted.

As described above, regarding a structure in which the electric storage apparatus 41 according to this embodiment is mounted on the vehicle 100, as viewed from the Z-axis direction, the surface pressure dispersion members 42 are disposed so as to avoid an area where the first vehicle frame member 101a and the second vehicle frame member 101b are disposed and loads are not input to the electric storage apparatus 41 from the Z-axis positive side. Therefore, the electric storage apparatus 41 according to this embodiment can be manufactured at a lower cost than the cost for manufacturing the electric storage apparatus 1 according to the first embodiment, and the electric storage apparatus 41 according to this embodiment can be made lighter than the electric storage apparatus 1 according to the first embodiment.

### Third Embodiment

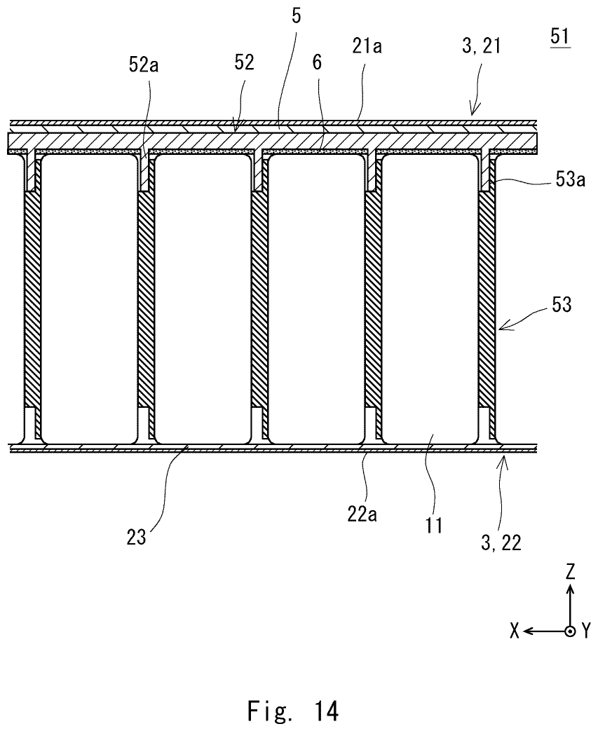

FIG. 14 is a diagram for explaining a configuration of an electric storage apparatus according to this embodiment between battery cells adjacent to each other in the X-axis direction. Note that an electric storage apparatus 51 according to this embodiment has a configuration substantially the same as that of each of the electric storage apparatus 1 according to the first embodiment and the electric storage apparatus 41 according to the second embodiment, and thus redundant descriptions thereof will be omitted and the same members will be described using the same reference symbols.

As shown in FIG. 14, the electric storage apparatus 51 according to this embodiment includes load receiving members 53 to each of which a load is transmitted from a surface pressure dispersion member 52. The load receiving members 53 can be formed of, for example, an adhesive member such as an elastomer sheet having an insulation property and elasticity, and each one of them is disposed between each adjacent pair of the battery cells 11 adjacent in the X-axis direction so as to join these battery cells 11 to each other.

Further, as shown in FIG. 14, an end part of the load receiving member 53 on the Z-axis positive side thereof is in contact with the surface pressure dispersion member 52 so that a load can be transmitted from the surface pressure dispersion member 52. Note that an end part of the load receiving member 53 on the Z-axis negative side thereof may or may not be in contact with a heat transfer member 23 disposed between the battery cell 11 and the lower case 22.

Note that, as shown in FIG. 14, the load receiving member 53 may include, for example, a notched part 53a in each of the end part of the load receiving member 53 on the Z-axis positive side thereof and the end part of the load receiving member 53 on the Z-axis negative side thereof. The notched parts 53a may be, for example, substantially rectangular as viewed from the Y-axis direction and extend in the Y-axis direction so as to cut out a corner part of the load receiving member 53 on the Z-axis positive and the X-axis positive sides and a corner part of the load receiving member 53 on the Z-axis negative and the X-axis positive sides.

As shown in FIG. 14, the surface pressure dispersion member 52 may include, for example, ribs 52a disposed at intervals in the X-axis direction and protruding toward the Z-axis negative side thereof. The ribs 52a may have a substantially rectangular shape as viewed from the Y-axis direction and extend in the Y-axis direction in a state in which each one of them is disposed between each adjacent pair of the battery cells 11 adjacent in the X-axis direction.

As shown in FIG. 14, the end part of the rib 52a on the Z-axis negative side thereof may be in contact with a bottom part of the notched part 53a while it is inserted into the notched part 53a of the load receiving member 53 on the Z-axis positive side thereof. Thus, the load input to the Z-axis negative side can be reliably transmitted from the surface pressure dispersion member 52 to the load receiving members 53.

As described above, the electric storage apparatus 51 according to this embodiment can transmit the load, which is input to the Z-axis negative side, from the surface pressure dispersion member 52 to the load receiving members 53, and can reduce excessive transmission of the load input to the Z-axis negative side of the battery cell 11 to the battery cell 11.

Moreover, the battery cells 11 adjacent to each other in the X-axis direction can be joined to each other through the load receiving member 53, and the rigidity of the battery module can be improved.

Note that the shape of the load receiving member 53 is not limited to the above-described shape, and may be any shape by which the load input to the Z-axis negative side can be transmitted from the surface pressure dispersion member 52, and for example, the notched parts 53a may be omitted.

Further, the shape of the surface pressure dispersion member 52 is not limited to the above-described shape, and may be any shape by which the load input to the Z-axis negative side can be transmitted to the load receiving members 53, and for example, the ribs 52a may be omitted.

### Fourth Embodiment

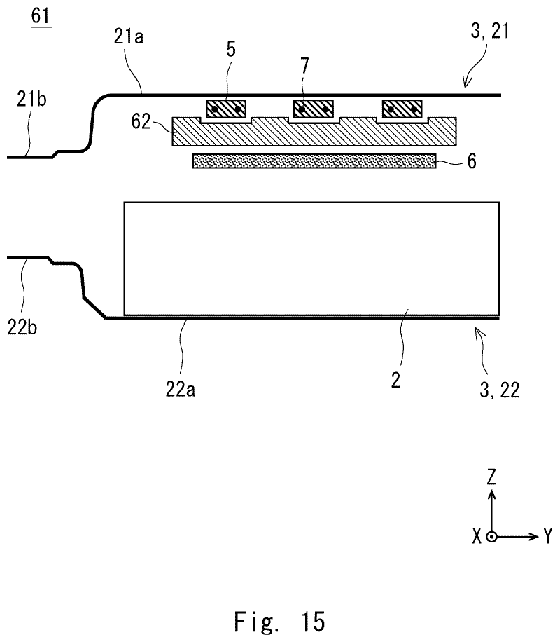

FIG. 15 is a Y-Z cross-sectional view for explaining an arrangement of an adhesive member, a cooling apparatus, a battery module, and the like in an electric storage apparatus according to this embodiment. Since an electric storage apparatus 61 according to this embodiment has substantially the same configuration as that of the electric storage apparatus 1 according to the first embodiment and the like, redundant descriptions thereof will be omitted, and as shown in FIG. 15, a cooling apparatus 62 is used as a typical example of an apparatus component.

Thus, the electric storage apparatus 61 according to this embodiment can be easily disassembled, for example, when the cooling apparatus 62 is replaced, and hence the maintainability of the electric storage apparatus 61 can be improved.

### Fifth Embodiment

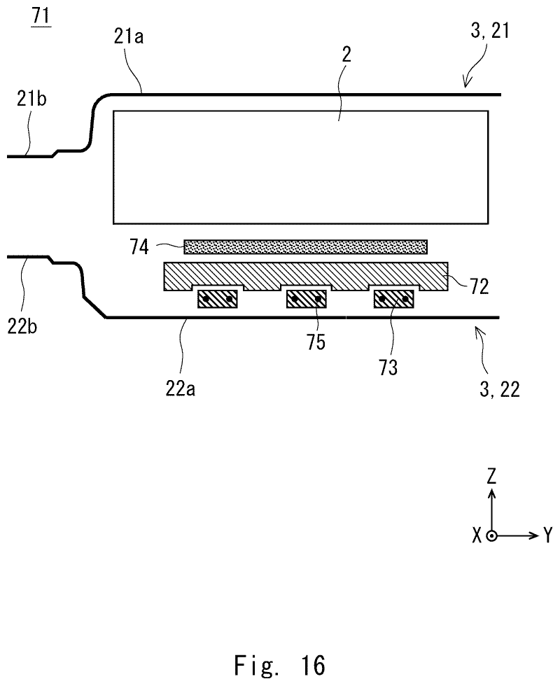

FIG. 16 is a Y-Z cross-sectional view for explaining an arrangement of an adhesive member, an apparatus component, a battery module, and the like in an electric storage apparatus according to this embodiment. Since an electric storage apparatus 71 according to this embodiment has substantially the same configuration as that of the electric storage apparatus 1 according to the first embodiment and the like, redundant descriptions thereof will be omitted, and as shown in FIG. 16, an apparatus component 72 such as a surface pressure dispersion member and a cooling apparatus is disposed on the Z-axis negative side with respect to the battery module 2.

As shown in FIG. 16, the apparatus component 72 is joined to the lower case 22 through a first adhesive member 73 and joined to the battery module 2 through a second adhesive member 74. Further, for example, wire rods 75 each having the same configuration as that of the wire rod 7 according to the first embodiment are disposed inside the first adhesive member 73.

Thus, the electric storage apparatus 71 according to this embodiment can be easily disassembled, and hence the maintainability of the electric storage apparatus 71 can be improved.

The present disclosure is not limited to the above-described embodiments and can be changed as appropriate without departing from the scope and spirit of the present disclosure. For example, the present disclosure may be implemented by combining the above-described first to fifth embodiments with one another as appropriate.

For example, the battery cell 11 according to the above-described embodiments extends in the X-axis direction, but may extend in the Y-axis direction. Further, the arrangement of the first electrode terminal 13 and the second electrode terminal 14 is not limited; these terminals only need to be provided on any surface of the battery case 12.

For example, in the electric storage apparatuses 1, 41, and 51 according to the above-described embodiments, the upper case 21 is joined to the surface pressure dispersion members 4, 42, and 52 by the first adhesive member 5, and the surface pressure dispersion member 4 is joined to the battery module 2 by the second adhesive member 6. However, the present disclosure is not limited thereto.

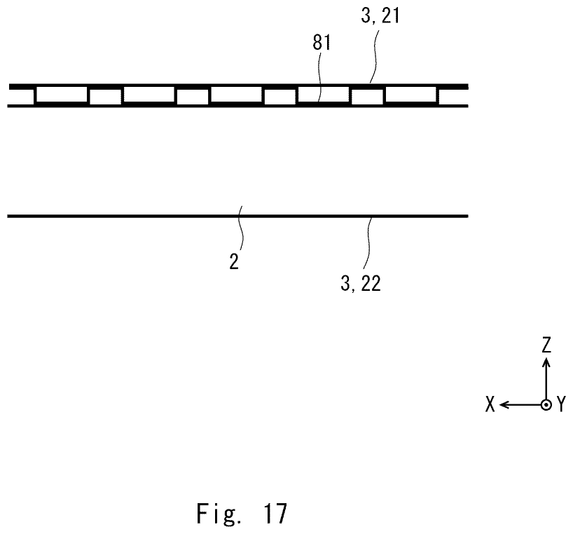

That is, as shown in FIG. 17, a surface pressure dispersion member 81 formed so as to have a hat-like shape may be joined to the upper case 21 by welding or the like. In this case, a configuration in which the second adhesive member 6 can be cut by the wire rod 7 may be employed.

For example, the arrangement, the shapes, and the like of the surface pressure dispersion members 4, 42, 52, 81 according to the above-described embodiments are merely examples, and any arrangement, shape, and the like by which the load input to the electric storage apparatuses 1, 41, 51, and the like from the Z-axis positive side can be distributed to the battery cells 11 may be employed. Further, the arrangement, the shapes, and the like of the cooling apparatus 62 and the apparatus component 72 according to the above-described embodiments are merely examples.

Further, for example, in the electric storage apparatus 1 and the like according to the above-described embodiments, the surface pressure dispersion member and the cooling apparatus are exemplified as apparatus components. However, the apparatus component may be any member disposed between the battery module 2 and the pack case 3, and the apparatus component may form a part of the case 3.

Therefore, the arrangement, the shapes, and the like of the first adhesive members 5 and 73 and the second adhesive members 6 and 74 may be changed as appropriate in accordance with the arrangement, the shapes, and the like of the apparatus component and the cooling apparatus. Further, the arrangement, the shapes, and the like of the wire rods 7 and 75 may be changed as appropriate in accordance with the arrangement, the shapes, and the like of the first adhesive members 5 and 73 and the second adhesive members 6 and 74.

In short, for example, the arrangement, the shape, and the like of the wire rod may be any arrangement, shape, and the like by which the adhesive member disposed between the battery module 2 and the pack case 3 can be cut, and the wire rod does not need to be disposed inside the first adhesive members 5 and 73 or the second adhesive members 6 and 74.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising:
a battery module comprising a plurality of battery cells;
a case configured to house at least a part of the battery module;
an apparatus component positioned between the battery module and the case; and
an adhesive member configured to bond the apparatus component to the battery module,
wherein the electric storage apparatus comprises a wire rod including a first part disposed inside the electric storage apparatus and a second part disposed outside the electric storage apparatus.

2. The electric storage apparatus according to claim 1, wherein the wire rod has an insulation property.

3. The electric storage apparatus according to claim 1, wherein the first part of the wire rod includes a part disposed at a position where the part overlaps the battery module as viewed from a direction in which the battery module and the apparatus component face each other.

4. The electric storage apparatus according to claim 1, wherein the first part of the wire rod includes a part fixed at a position where the part overlaps the battery module as viewed from a direction in which the battery module and the apparatus component face each other.

5. The electric storage apparatus according to claim 1, wherein the first part of the wire rod includes a part that is in contact with the adhesive member.

6. The electric storage apparatus according to claim 1, wherein the first part of the wire rod is curved as viewed from a direction in which the battery module and the apparatus component face each other.

7. The electric storage apparatus according to claim 6, wherein the wire rod is disposed inside the adhesive member.

8. The electric storage apparatus according to claim 7, wherein
the apparatus component is a surface pressure dispersion member,
the adhesive member comprises a first adhesive member configured to join the surface pressure dispersion member to the case, and a second adhesive member configured to join the surface pressure dispersion member to the battery module, and
the wire rod is disposed inside the first adhesive member.

9. The electric storage apparatus according to claim 8, comprising a load receiving member disposed between each adjacent pair of the battery cells, a load being transmitted from the surface pressure dispersing member to each of the load receiving members.

10. The electric storage apparatus according to claim 9, wherein the surface pressure dispersion member comprises ribs protruding so that each one of them is disposed between each adjacent pair of the battery cells, the ribs being configured to press the load receiving members.

11. The electric storage apparatus according to claim 10, wherein the load receiving member has an insulation property.

12. The electric storage apparatus according to claim 1, wherein the battery cell comprises an electrode terminal on at least one of a pair of surfaces thereof that face each other in a direction perpendicular to a direction in which the battery module and the apparatus component face each other.

13. The electric storage apparatus according to claim 1, wherein the apparatus component forms at least a part of the case.

14. A vehicle mounting structure of the electric storage apparatus according to claim 1, comprising:
a first vehicle frame member disposed above the battery module and extending in a width direction of a vehicle; and
a second vehicle frame member disposed above the battery module so as to be spaced apart from the first vehicle frame member in a front-rear direction of the vehicle and extending in the width direction of the vehicle, wherein
the apparatus component is a surface pressure dispersion member, and
the surface pressure dispersion member is disposed between the first vehicle frame member and the second vehicle frame member.

15. The vehicle mounting structure of the electric storage apparatus according to claim 14, wherein each of the first vehicle frame member and the second vehicle frame member is a seat cross.

16. An electric storage apparatus comprising:
a battery module comprising a plurality of battery cells;
a case configured to house at least a part of the battery module; and
an adhesive member configured to bond the case to the battery module,
wherein the electric storage apparatus comprises a wire rod including a first part disposed at a position where the first part overlaps the battery module as viewed from a direction in which the battery module and the case face each other, and a second part disposed at a position where the second part does not overlap the battery module as viewed from a direction in which the battery module and the case face each other.

17. The electric storage apparatus according to claim 16, wherein the battery cell comprises an electrode terminal on at least one of a pair of surfaces thereof that face each other in a direction perpendicular to a direction in which the battery module and the case face each other.
